(19) United States
(12) Patent Application Publication
(10) Pub. No.: US 2025/0134116 A1
(43) Pub. Date: May 1, 2025

(54) EDIBLE COMPOSITIONS COMPRISING DEAMIDATED LEGUME PROTEIN ISOLATES

(71) Applicant: CORN PRODUCTS DEVELOPMENT, INC., WESTCHESTER, IL (US)

(72) Inventors: Michael FREUND, Bridgewater, NJ (US); Felix AKHARUME, Bridgewater, NJ (US); Elena DE LA PENA, Bridgewater, NJ (US); Matthew YURGEC, Bridgewater, NJ (US)

(21) Appl. No.: 18/834,680

(22) PCT Filed: Jan. 27, 2023
(86) PCT No.: PCT/US2023/011742

§ 371 Date: Jul. 31, 2024

Related U.S. Application Data
(60) Provisional application No. 63/306,684, filed on Feb. 4, 2022.

(51) Int. Cl. A21D 2/26; A21D 2/18; A21D 13/066; A23J 3/14

(52) U.S. Cl. CPC A21D 2/266; A21D 2/186; A21D 13/066; A23J 3/14

(57) ABSTRACT

The technology disclosed in this specification is directed to baked goods comprising a deamidated legume protein isolate. In some embodiments the baked good is gluten free. In some embodiments the deamidated legume protein isolate is a deamidated pea protein isolate. The baked goods described in this specification have from about 0.5% to about 5% wt. % deamidated legume protein.

The technology disclosed in this specification pertains to deamidated legume protein isolates, and more particularly to uses of deamidated legume protein isolates in edible compositions.

Legume protein isolates are useful food ingredients that are commonly used to provide nutrition or structure to an edible composition. This specification describes legume protein isolates modified by a deamidation process to make deamidated legume proteins. Deamidation is a process that converts at least some of the asparagine and glutamine residues in a protein or polypeptide into aspartic acid and glutamic acid residues (respectively). This specification also discloses edible compositions comprising the disclosed deamidated legume protein isolates and more specifically baked good including gluten free baked goods using deamidated legume protein.

A key challenge in formulating gluten free baked goods is replacing the functionalities of gluten. One functionality is to form a network in the batter or dough of a baked good that can hold moisture. In breads, rolls, and similar compositions (which are generally egg free when wheat flour is used) it is common to use dried egg whites in place of gluten. But dried egg whites are a common allergen and cause the baked good to be non-vegan. Also, this specification demonstrates that egg whites can be replaced with a deamidated legume protein isolate to provide gluten free baked goods that are softer than gluten free baked goods made using a legume protein isolate (non-deamidated).

In one aspect this specification describes edible compositions comprising deamidated legume protein isolates. More specifically, deamidated legume protein isolates are protein rich compositions obtained by isolating legume protein from other components in a legume seed or legume flour and concurrently or subsequently to the isolation process, subjecting the legume protein to a deamidation reaction that converts at least some of the asparagine or glutamine residues in the proteins to aspartic acid or glutamic acid residues.

Any process for isolating legume protein from legume seed or legume flour and deamidating the protein may be used. An illustrative process follows, describing a process that first isolates and then deamidates legume protein. Legume protein can be isolated from other components of the legume seed using known methods. For example International Patent Application PCT/US2022/019911, which is incorporated in its entirety into this specification by reference,, describes a method for isolating pea protein from pea flour by adjusting the pH of a slurry containing pea flour. Such processes take advantage of the changes in the solubility of pea protein relative to solubility of other components in the flour at different pHs. In the described process, legume proteins tend to be highly soluble at pHs above 8 while starch and fiber remain highly insoluble. Once dissolved in water at pH around 8, legume protein solution can be separated from insoluble like matter (like starch or fiber) using one or more method of filtration and centrifugation. The dissolved protein can then be recovered by lowering the pH to about 4 where the protein is highly insoluble. The precipitated protein can then be removed from the aqueous solution by using one or more of filtration and centrifugation, and then the protein can be further dried to an equilibrium moisture content.

Referring now to the deamidation process, deamidation can occur enzymatically or chemically. Generally the process converts amide functional groups in asparagine or glutamine to aspartic acid or glutamic acid groups. In at least some embodiments the deamidation reactions is achieved by the use of a glutaminase enzyme, which converts glutamine residues in the legume protein isolate to glutamic acid residues. Illustrative methods for deamidating legume proteins (in particular pea proteins) are described in International Patent Application PCT/US2021/033127, which is incorporated herein by reference.

Deamidated legume protein isolates in any embodiment described in this specification obtained have protein content (dry weight basis or as is weight basis) of at least about 70%, or at least about 75%. Still other embodiment have protein content or at least about 75% or up to about 90%, or in still embodiments in a range from about 75% (wt.%) to about 85% protein. In any embodiment a deamidated legume protein isolate described in this specification, has a degree of deamidation of between 10% and about 25%, or about 10% and about 20%, or about 12% to about 20% or about 15% to about 20% compared to the base legume protein. In at least some embodiments a deamidated legume protein isolate as described in this specification is a deamidated pea protein isolate. Other deamidated legume protein isolates can be derived from sources such as lentil, fava bean, chickpea.

With reference to baked goods comprising a deamidated legume protein isolate, in any embodiment described in this specification, a baked good comprises a starch component and a deamidated legume protein isolate in an amount in a range from at least about 0.5% (wt.%) to about 5%, or 0.5% to about 2%, or from about 1% to about 5%, or from about 1% to about 3%, or from about 1% to about 2.5%, or from about 1% to about 2% of the baked good. In at least some embodiments, a baked good, as described in this specification, the deamidated legume protein isolate has a degree of deamidation of between about 10% and about 25%, or about 10% to about 20%, or about 12% to about 20%, or about 15% to about 20%.

In any embodiment of a baked good described in this specification the starch component is in an amount 30% to about 70%, or about 35% to about 70%, about 35% to about 60%, or from 35% to about 50%, or from about 35% to about 45% wt.% of the baked good. In any embodiment of an edible composition described in this specification, the composition further comprising a starch, wherein the starch is selected from the group consisting of corn, potato, tapioca, rice, pea, waxy corn, waxy potato, waxy tapioca, waxy rice and mixtures.

In any embodiment, an edible composition as described in this specification further comprises a starch, which may be modified or unmodified. Modified starches modified using chemical mean, enzymatic means, or physical means, and mixtures thereof. Use chemical modifications include crosslinked including by using phosphate or adipate, or stabilization including by hydroxypropyl or acetyl moieties. Useful starch may be converted or hydrolyzed using shear, enzyme, acid, or oxidation. Starch may also be modified usefully by oxidation for purposes other than hydrolysis. Useful starch may be physically modified such as by thermal inhibition, annealing, gelatinization, or heat moisture treatments. Modified and unmodified starch may be pregelatinized or otherwise made cold water soluble.

In at least some embodiment, this specification describes a baked good wherein the component comprises at least one modified starch have a modification selected from the group consisting of pregelatinization, thermal inhibition, heat-moisture treatments, annealing, and mixtures thereof.

In at least some the edible composition the starch is a thermally inhibited starch. Here, thermally inhibited starches can be made using any process. An illustrative processes dehydrates the starch and heats the dehydrated starch to functionalize the starch so that it functions like a chemically crosslinked starch. More detailed methods of manufacture and embodiments of thermally inhibited starches are disclosed for example in U.S. Pat. No. 5,725,676, which is incorporated into this document by reference in its entirety. Thermally inhibited starches are also commercially available (for example from Ingredion Incorporated). In any embodiment of the edible composition described in this specification, the starch is in an amount from about 1% to about 10%, or to about 5% (wt. %).

In at least some embodiments a baked good as described in this specification is gluten free.

Also described in this specification are doughs that when baked make baked goods as described in this specification. The doughs described in this specification have substantially the same composition as the baked good but, being unbaked, comprise more moisture. Generally the moisture content will be in an amount between about 30% and 70% of the dough. In any embodiment, this specification describes a dough comprising a starch component, a moisture content from about 30% to about 70% by weight, and a deamidated legume protein isolate in an amount in a range from at least about 0.5% (wt. %) to about 5%, or 0.5% to about 2%, or from about 1% to about 5%, or from about 1% to about 3%, or from about 1% to about 2.5%, or from about 1% to about 2% of the dough. In any embodiment, the dough comprises an aqueous component present in an amount wherein the moisture content of the dough is in a range from 30% to about 70%, or about 35% to about 70%, about 35% to about 60%, or from 35% to about 50%, or from about 35% to about 45% wt. % of the dough.

In various embodiments the degree of deamidation of the legume protein isolate, types of starch useful in the starch component, and amount of in the starch component is as described in this specification for the baked good.

In at least some embodiments, this specification describes a dough wherein starch the modification is selected from the group consisting of pregelatinization, thermal inhibition, heat-moisture treatments, annealing, and mixtures thereof.

This specification also describes methods of making a baked good comprising mixing an aqueous component, starch component and deamidated legume protein isolate to make a dough and then optionally baking the dough to make a baked good.

Other ingredients that can be useful added to the baked goods or doughs described in this specification follow.

In any embodiment, an edible composition as described in this specification further comprises a sweetener. Useful sweeteners include honey, allulose, tagatose, fructose, glycerol, sucrose, rebaudiosides (A, B, J, M, etc.), and glucosylated stevia glycosides, corn syrups including high fructose corn syrups. Sweeteners may be provided in solid, or powdered, or liquid, or syrup form.

In any embodiment, an edible composition as described in this specification further comprises a fiber. Useful fibers may include cellulosic fibers from any botanical source, resistant starches, soluble fibers such as polydextrose or short chain fructooligosaccharides.

In any embodiment, an edible composition as described in this specification further comprises a gum or gum-like material. Useful gums and gum like materials include gelling starches, gum Arabic, xanthan gum, tara gum, konjac, carrageenan, locust bean gum, gellan gum, guar gum, pectin, and modified celluloses like carboxymethyl cellulose, and mixtures thereof.

In any embodiment, an edible composition comprising a deamidated legume protein isolate described in this specification useful fats include oils including vegetable oils such as corn oil, olive oil, canola oil, sunflower oil, rapeseed oil, palm oil, coconut oil.

Useful fats (other than vegetable oils) included animal fats and dairy fats. Most preferably the fat is a diary fat or butter fat which may be provided like cow's milk or cow's milk cream of desired fat content.

Useful aqueous ingredients include water, milk (including non-fat milk), syrups, or other carbohydrate containing liquids, or acidic liquids, or basic liquids.

In any embodiment, an edible composition comprising a deamidated legume protein isolate described in this specification may further comprises various other flavorings and coloring commonly used in edible composition.

The subject matter described in this specification can be better understood with reference to the following definitions and guidance for construing the terms in this specification.

The term “degree of deamidation” in this specification refers to the amount of ammonia released during a deamidation reaction compared to the total ammonia of releasable by the protein. In practice degree of deamidation can also be determined by comparing the amount of ammonia released by a protein of interest compared to a reference protein of the same type that was not deamidated. For example, it is common practice that legume protein isolates are substantially comprised of globular type protein proteins, which can be determined by the molecular weight measurements of the proteins in the isolate. Taking as a further example a deamidated pea protein isolate comprised substantially of globular type proteins, its degree of deamidation can be determined by comparing the amount of ammonia released by the deamidated pea protein isolate of interest against the total releasable ammonia of a non-deamidated pea protein isolate of the same type.

Within this specification, degree of deamidation is reported as a percentage. Degree of deamidation can be calculated using any suitable method in the art. A useful test for measuring degree of deamidation follows. Disperse protein (deamidated protein or reference unmodified protein) in slurry with 2M H₂SO₄ and incubate solution at boiling temperature (about 100° C.) for 2 hours. Mix three volumes of resultant slurry with 1 volume of 40% trichloroacetic acid (“TCA”) solution to obtain mixture having a final TCA concentration of 10%. Centrifuged at 4,000 g for 10 min. Free ammonia content in the supernatant is determined using a commercial ammonia analysis kit (Megazyme). Degree of deamidation equals total ammonia release divided by total ammonia obtainable multiplied by 100.

Within this specification the term “starch component” means all starch and flour ingredients within a baked good.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification is further described by reference to the following aspects, which are not limiting in any way.

A baked good comprising:
a. a starch component; and
b. a deamidated legume protein isolate in an amount in a range from about 0.5% (wt. %) to about 5%, or 0.5% to about 2%, or from about 1% to about 5%, or from about 1% to about 3%, or from about 1% to about 2.5%, or from about 1% to about 2% of the baked good;
   wherein optionally, the deamidated legume protein isolate is a deamidated pea protein isolate.

The baked good of claim 1 wherein the deamidated legume protein isolate has a degree of deamidation of between about 10% and about 25%, or about 10% to about 20%, or about 12% to about 20%, or about 15% to about 20%.

The baked good of claim 1 or 2 wherein the starch component is present in an amount in a range from at least about 30% to about 70%, or about 35% to about 70%, about 35% to about 60%, or from 35% to about 50%, or from about 35% to about 45% wt. % of the baked good.

The baked good of any one of claims 1 to 3 wherein the starch component is one or more starches selected from the group consisting of corn starch, pea starch, tapioca starch, rice starch, potato starch, sago starch, waxy corn starch, waxy tapioca starch, waxy rice starch, and waxy potato starch and mixtures thereof.

The baked good of any one of claims 1 to 4 wherein the starch component comprises a modified starch, wherein the modification is selected from the group consisting hydroxypropylation, acetylation, crosslinking, pregelatinization, thermal inhibition, heat-moisture treatments, annealing, and mixtures thereof.

The baked good of any one of claims 1 to 5 wherein the starch component comprises a modified starch, wherein the modification is selected from the group consisting hydroxypropylation, acetylation, crosslinking, pregelatinization, and mixtures thereof.

The baked good of any one of claims 1 to 6 wherein starch is a modified starch and the modification is selected from the group consisting of pregelatinization, thermal inhibition, heat- moisture treatments, annealing, and mixtures thereof.

The baked good of any one of claims 1 to 7, wherein the baked good is a gluten free baked good.

A dough for making a baked good comprising:
a. a starch component;
b. an aqueous component in an amount of about 30% to about 70% wt.% of the dough; and
c. a deamidated legume protein isolate in an amount in a range from at least about 0.5% (wt.%) to about 5%, or 0.5% to about 2%, or from about 1% to about 5%, or from about 1% to about 3%, or from about 1% to about 2.5%, or from about 1% to about 2% of the baked good of the dough.
   wherein optionally, the deamidated legume protein isolate is a deamidated pea protein isolate.

The dough of claim 9 wherein the deamidated legume protein isolate has a degree of deamidation of about 10% and about 25%, or about 10% to about 20%, or about 12% to about 20%, or about 15% to about 20%.

The dough of claim 9 or 10 wherein the starch component is present in an amount in a range from 30% to about 70%, or about 35% to about 70%, about 35% to about 60%, or from 35% to about 50%, or from about 35% to about 45% wt. % of the baked good.

The dough of any one of claims 9 to 11 wherein the aqueous component is present in an amount from about 30% to about 70% (wt. %), or from about 35% up to about 70%, or from by about 35% or from about 60%, or from about 35% to about 50%, or from about 35% to about 45% wt. % of the baked good.

The dough of any one of claims 9 to 12 wherein the starch component is one or more starches selected from the group consisting of corn starch, pea starch, tapioca starch, rice starch, potato starch, sago starch, waxy corn starch, waxy tapioca starch, waxy rice starch, and waxy potato starch and mixtures thereof.

The dough of any one of claims 9 to 13 wherein the starch component comprises a modified starch, wherein the modification is selected from the group consisting hydroxypropylation, acetylation, crosslinking, pregelatinization, thermal inhibition, heat-moisture treatments, annealing, and mixtures thereof.

The dough of any one of claims 9 to 14 wherein the starch component comprises a modified starch, wherein the modification is selected from the group consisting hydroxypropylation, acetylation, crosslinking, pregelatinization, and mixtures thereof.

The dough of claim 14 wherein the modification is selected from the group consisting of pregelatinization, thermal inhibition, heat-moisture treatments, annealing, and mixtures thereof.

The dough of any one of claims 9 to 16, wherein the dough is a gluten free baked good.

A method comprising:
a. mixing a starch component,
b. an aqueous component in an amount from about 30 to about 70% (wt.%),
c. and a deamidated legume protein isolate in an amount 0.5% (wt. %) to about 5%, or 0.5% to about 2%, or from about 1% to about 5%, or from about 1% to about 3%, or from about 1% to about 2.5%, or from about 1% to about 2% of the baked good of the dough to obtain a dough;
   wherein optionally, the deamidated legume protein isolate is a deamidated pea protein isolate;
   wherein, optionally, the dough is baked to make a baked good.

The method of claim 18 wherein the deamidated legume protein isolate has a degree of deamidation of between about 10% and about 25%, or about 10% to about 20%, or about 12% to about 20%, or about 15% to about 20%.

The method of any one of claim 18 or 19 wherein the starch component wherein the starch component is present in an amount in a range from 30% to about 70%, or about 35% to about 70%, about 35% to about 60%, or from 35% to about 50%, or from about 35% to about 45% wt. % of the baked good.

The method of any one of claims 18 to 20 wherein the aqueous component is in an amount from about 30% to about 70% (wt. %), or from about 35% up to about 70%, or from by about 35% or from about 60%, or from about 35% to about 50%, or from about 35% to about 45% wt. % of the baked good.

The method of any one of claims 18 to 21 wherein the starch component is one or more starches selected from the group consisting of corn starch, pea starch, tapioca starch, rice starch, potato starch, sago starch, waxy corn starch, waxy tapioca starch, waxy rice starch, and waxy potato starch and mixtures thereof.

The method of any one of claims 18 to 22 wherein the starch component comprises a modified starch, wherein the modification is selected from the group consisting hydroxypropylation, acetylation, crosslinking, pregelatinization, thermal inhibition, heat-moisture treatments, annealing, and mixtures thereof.

The method of any one of claims 18 to 23 wherein the starch component comprises a modified starch, wherein the modification is selected from the group consisting hydroxypropylation, acetylation, crosslinking, pregelatinization, and mixtures thereof.

The method any one of claims 18 to 24 wherein starch is a modified starch and wherein the modification is selected from the group consisting of pregelatinization, thermal inhibition, heat-moisture treatments, annealing, and mixtures thereof.

The method of any one of claims 18 to 25, wherein the baked good is a gluten free baked good.

Use of a deamidated legume protein isolate as described in any foregoing claim in a dough or baked good as described in any foregoing claim;
wherein optionally, the deamidated legume protein isolate is a deamidated pea protein isolate.

The use of the deamidated legume protein isolate as described in claim 27 to reduce a firmness of the baked good.

The technology disclosed in this specification is further described by reference to the following examples, which are not limiting in any way.

### EXAMPLE 1: GLUTEN FREE BUN WITH DEAMIDATED AND NATIVE PEA PROTEIN ISOLATES

Deamidated peat protein isolates used in the following examples were made using process like those described in International Patent Application PCT/US2021/033127, which is incorporated herein by reference. Gluten free baked goods were made using egg white powder, and pea protein isolate or deaminated pea protein isolate, and were measured for firmness after storage at ambient temperatures after 1 and 7 days. Gluten free buns were made using the formula in Table 1 (reported in baker's wt. %) and 2 (reported in true wt. %).

TABLE 1
Gluten Free Bun Formulation (Baker's wt. %)

| | Egg | Pea | Deamidated |
|---|---|---|---|
| | white | protein | pea |
| | powder | isolate | protein isolate |
| | (Baker's | (Baker's | (Baker's |
| INGREDIENTS | wt. %) | wt. %) | wt %.) |
| Gluten Free Starch Mix* | 100.00 | 100.00 | 100.00 |
| Psyllium Husk | 2.91 | 2.91 | 2.91 |
| Granulated Sugar | 8.28 | 8.28 | 8.28 |
| Egg White Powder | 3.74 | 0.00 | 0.00 |
| Pea protein isolate | 0.00 | 3.74 | 0 |
| Deamidated pea protein isolate | 0.00 | 0.00 | 3.74 |
| Salt | 2.04 | 2.04 | 2.04 |
| Hydroxypropylmethyl cellulose | 4.06 | 4.06 | 4.06 |
| High fructose corn syrup | 5.10 | 5.10 | 5.10 |
| High amylose corn starch | 5.83 | 5.83 | 5.83 |
| (resistant starch) | | | |
| Canola Oil | 12.19 | 12.19 | 12.19 |
| Water, Lukewarm* | 97.06 | 99.06 | 98.56 |
| Yeast, Instant | 1.63 | 1.63 | 1.63 |
| Total | 242.84 | 242.84 | 242.84 |

PRECISA ® BAKE GF texturizing system available from Ingredion Incorporated

TABLE 2
Gluten Free Bun Formulation (Baker's wt. %)

| | Egg | Pea | Deamidated |
|---|---|---|---|
| | white | protein | pea |
| | powder | isolate | protein isolate |
| | (True | (True | (True |
| INGREDIENTS | wt. %) | wt. %) | wt %.) |
| Gluten Free Starch Mix* | 41.18 | 40.76 | 41.18 |
| Psyllium Husk | 1.2 | 1.19 | 1.20 |
| Granulated Sugar | 3.41 | 3.37 | 3.41 |
| Egg White Powder | 1.54 | 0.00 | 0.00 |
| Pea protein isolate | 0 | 1.52 | 0.00 |
| Deamidated pea protein isolate | 0 | 0.00 | 1.54 |
| Salt | 0.86 | 0.83 | 0.84 |
| Hydroxypropylmethyl cellulose | 1.67 | 1.65 | 1.67 |
| High fructose corn syrup | 2.1 | 2.08 | 2.10 |
| High amylose corn starch (resistant | 2.4 | 2.38 | 2.40 |
| starch) | | | |
| Canola Oil | 5.02 | 4.97 | 5.02 |
| Water, Lukewarm* | 39.97 | 40.58 | 39.97 |
| Yeast, Instant | 0.67 | 0.66 | 0.67 |
| Total | 100 | 100 | 100.00 |

Gluten free buns were made as follows. In a conventional stand mixer bowl, corn syrup was dissolved into lukewarm water (77° F./25° C.) and yeast and psyllium husk were added to mixture, which was left for about 1.5 minutes. Oil was then stirred in and remaining ingredients were added to the water solution while mixing on slow speed (speed setting #1) for 1.5 minutes. During mixing speed was increased speed to #2 or #3 for 1 minute or until dough stuck to the side of the bowl. About 60 grams of dough was hand-rolled into ball shape and placed on sheet trays lined with parchment paper far enough from each other to allow dough to expand during cooking without dough spreading into an adjacent roll. The rolls were proofed for 60 minutes in a proofer set at 95° F. (35° C.) with a relative humidity of about 85%. Dough was then baked in convection oven at 375° F. (about 190° C.) for 25 minutes. Trays were rotated about halfway through baking for even cooking. The rolls were then cooled to about ambient temperature and packed in sealable bags. Samples were measured for volume and were stored for firmness analysis at 1 day's storage ambient temperature, 7 day's storage ambient temperature, and 7 day's storage at freezing temperature (about 0° F./−18° C.).

Volume was measured using Volscan Profiler 600. All samples had similar volume of about 200 mL with no statistically significant difference detected among samples.

Bun firmness was measured by TA. XT Plus C texture Analyzer. The probe used was a P/25L Cylinder 25 mm with sharp edges, in acrylic (product n. TA-11 by Texture Technologies). The probe was advanced at a speed of Test speed: 1.7 mm/s. Data recording was triggered at a force of 10 g.

Measurements were taken 1 day after roll production and after 7 days of ambient storage. After 1 day's and after 7 day's storage the gluten free roll made with deamidated pea protein isolate had the lowest firmness compared to the roll made with powdered egg white and with the roll made with pea protein isolate. Firmness measurements are reported in Table 3 in grams-force.

TABLE 3
1- and 7-Day Firmness of GF Buns

| | Firmness (g) | Firmness (g) |
|---|---|---|
| | Day 1 | Day 7 |
| Egg white powder | 206.3 | 898.5 |
| Pea protein Isolate | 233.9 | 935.1 |
| Deamidated pea | 175.9 | 840.2 |
| protein isolate | | |

On day 1 and on Day 7 the deaminated protein sample performed the best, displaying lower firmness than the unmodified pea protein isolate and the egg white control.

1. A baked good comprising:
a. a starch component; and
b. a deamidated legume protein isolate in an amount in a range from about 0.5% (wt. %) to about 5%, of the baked good;
wherein optionally, the deamidated legume protein isolate is a deamidated pea protein isolate.

2. The baked good of claim 1 wherein the deamidated legume protein isolate has a degree of deamidation of between about 10% and about 25%.

3. The baked good of claim 1 wherein the starch component is present in an amount in a range from at least about 30% to about 70% of the baked good.

4. The baked good of claim 1 wherein the starch component is one or more starches selected from the group consisting of corn starch, pea starch, tapioca starch, rice starch, potato starch, sago starch, waxy corn starch, waxy tapioca starch, waxy rice starch, and waxy potato starch and mixtures thereof.

5. The baked good of claim 1 wherein the starch component comprises a modified starch, wherein the modification is selected from the group consisting hydroxypropylation, acetylation, crosslinking, pregelatinization, thermal inhibition, heat-moisture treatments, annealing, and mixtures thereof.

6. The baked good of claim 1 wherein the starch component comprises a modified starch, wherein the modification is selected from the group consisting hydroxypropylation, acetylation, crosslinking, pregelatinization, and mixtures thereof.

7. The baked good of claim 1 wherein starch is a modified starch and the modification is selected from the group consisting of pregelatinization, thermal inhibition, heat-moisture treatments, annealing, and mixtures thereof.

8. The baked good of claim 1, wherein the baked good is a gluten free baked good.

9. A dough for making a baked good comprising:
a. a starch component;
b. an aqueous component in an amount of about 30% to about 70% wt. % of the dough; and
c. a deamidated legume protein isolate in an amount in a range from at least about 0.5% (wt. %) to about 5% of the baked good of the dough.
wherein optionally, the deamidated legume protein isolate is a deamidated pea protein isolate.

10. The dough of claim 9 wherein the deamidated legume protein isolate has a degree of deamidation of about 10% and about 25%.

11. (canceled)

12. (canceled)

13. (canceled)

14. (canceled)

15. (canceled)

16. The dough of claim 9 wherein the starch component comprises a modified starch and wherein the modification is selected from the group consisting of pregelatinization, thermal inhibition, heat-moisture treatments, annealing, and mixtures thereof.

17. The dough of claim 9, wherein the dough is a gluten free baked good.

18. A method comprising:
a. mixing a starch component,
b. an aqueous component in an amount from about 30 to about 70% (wt. %),
c. and a deamidated legume protein isolate in an amount 0.5% (wt. %) to about 5%;
wherein optionally, the deamidated legume protein isolate is a deamidated pea protein isolate;
wherein, optionally, the dough is baked to make a baked good.

19. The method of claim 18 wherein the deamidated legume protein isolate has a degree of deamidation of between about 10% and about 25%.

20. The method claim 18 wherein the starch component wherein the starch component is present in an amount in a range from 30% to about 70% of the baked good.

21. The method of claim 18 wherein the aqueous component is in an amount from about 30% to about 70% (wt. %) of the baked good.

22. The method of claim 18 wherein the starch component is one or more starches selected from the group consisting of corn starch, pea starch, tapioca starch, rice starch, potato starch, sago starch, waxy corn starch, waxy tapioca starch, waxy rice starch, and waxy potato starch and mixtures thereof.

23. (canceled)

24. The method of claim 18 wherein the starch component comprises a modified starch, wherein the modification is selected from the group consisting hydroxypropylation, acetylation, crosslinking, pregelatinization, and mixtures thereof.

25. The method of claim 18 wherein starch is a modified starch and wherein the modification is selected from the group consisting of pregelatinization, thermal inhibition, heat-moisture treatments, annealing, and mixtures thereof.

26. The method of claim 18, wherein the baked good is a gluten free baked good.

27. (canceled)

28. (canceled)
